(19) United States
(12) Patent Application Publication
(10) Pub. No.: US 2009/0258127 A1
(43) Pub. Date: Oct. 15, 2009

(54) Container Rack of a Food Warmer and Method of Use

(76) Inventor: Joshua Holtz, West Orange, NJ (US)

Correspondence Address: THE LAW OFFICES OF THOMAS L. ADAMS, 120 EAGLE ROCK AVENUE, Suite 130, EAST HANOVER, NJ, 07936, US

(21) Appl. No.: 12/103,044

(22) Filed: Apr. 15, 2008

(51) Int. Cl. B65B 25/00; A47G 29/00; A47J 43/00

(52) U.S. Cl. 426/412; 211/72; 211/85.18; 99/483

(57) ABSTRACT

A rack can hold a flanged, sheet metal container whose height is at least three quarters of its overall width. The rack has a number of legs supporting a hoop. The legs extend downwardly and outwardly, and may terminate in feet spaced equidistantly in a pattern exceeding the compass of the hoop. The container can be filled with a non-viscous food such as soup and placed in the hoop, supported at least partially on its flange. The rack provides clearance under the container for direct combustion heating thereof. The container may be disposable.

### BACKGROUND OF THE INVENTION

1. Field of the Invention

The present invention relates to food warmers, and in particular, to apparatus and methods employing sheet metal containers supported by their flange in a rack over a heater.

2. Description of Related Art

When preparing and serving food for social or business gatherings the ease of preparation and cleanup is important. Traditional pots and pans are relatively heavy and must often be scoured afterwards to ensure cleanliness for subsequent use. Also, these pots and pans are not appropriate for serving food since they often have long handles or profiles that are inconvenient or unattractive for service. In addition, such pots and pans can quickly lose heat, allowing its contents to fall below a serving temperature.

Food is often prepared in a shallow rectangular tray that is disposable. These trays can be made of sheet metal that is stamped to form a flange and wrinkled sidewalls. Food can be prepared separately and placed in the tray by a consumer or by a caterer who will transport the tray from a place of business to a consumer's home or place of business. The transported tray will usually be covered with an aluminum lid.

At the place of service, water pans similar to the food trays can be placed in wire racks that have a hoop for supporting the water pan on its flange. After the water pan is partially filled with water, the food tray can be inserted into the water pan. Containers of combustible gel placed under the trays can be ignited to heat the water in the water pan. Since the burning gel heats the water, hotspots are not created on the food tray that would tend to bum its contents. After the food has been served and consumed, the empty food trays can be discarded.

Cauldrons for cooking soups and other non-viscous foods may have a semicircular handle that is placed into an overhead hook for suspending the cauldron over an open fire. A pot for cooking such foods can be placed on a rack over the burner of a kitchen range. A tureen can have an internal electric heater for cooking a soup or other non-viscous foods.

See U.S. Pat. Nos. 1,688,846; 2,673,053; 1,947,932; 4,026,435; 4,899,722; 4,920,873; 4,969,569; 5,282,458; 5,287,800; 5,301,909; 5,921,513; 5,921,530; 6,313,446; 6,457,601; 6,520,354; 6,892,896; 7,021,202; 7,112,764; and D181,149. See also U.S. Published Patent Applications Nos. 2003/0034318; 2005/0167381; and 2005/0218274.

### SUMMARY OF THE INVENTION

In accordance with the illustrative embodiments demonstrating features and advantages of the present invention, there is provided a container rack adapted to hold a flanged, sheet metal container whose height is at least three quarters of its overall width. The rack has at least four legs supporting a hoop. The hoop is dimensioned to receive the container and support it at least partially on its flange. The legs extend downwardly and outwardly, and terminate in feet spaced equidistantly in a pattern exceeding the compass of the hoop.

In accordance with another aspect of the invention, there is provided a warmer for foods. The warmer has a sheet metal container with a flange and a rack adapted to hold the container. The rack includes (a) a hoop dimensioned to receive the container and support it on its flange, and (b) a plurality of legs attached to the rack near the hoop. The legs extend downwardly and outwardly and terminate in feet spaced equidistantly in a pattern exceeding the compass of the hoop. The rack provides clearance under the container for combustion heating.

In accordance with yet another aspect of the invention, a method is provided for warming anon-viscous food. The method employs a flanged, sheet metal container. The method includes the step of filling the container with the food. Another step is supporting the container at least partially on its flange with clearance below the container. The method includes the step of applying combustion heat under and directly to the container. Another step is discarding the container after one use.

By employing apparatus and methods of the foregoing type an improved technique is achieved for warming food. In the disclosed embodiment a round container made of sheet aluminum is formed with a flange. The container is relatively deep, which is convenient for holding soup or other non-viscous foods. In contrast, carrying a relatively shallow tray filled with liquid would frequently lead to spillage, due to the unavoidable disturbances such as a slight tipping of the tray or the inevitable wave motion occurring when moving the tray.

Non-viscous food such as soup has a large liquid content, which can easily splash out of a container that is tipped, jarred, or otherwise disturbed. For purposes of this specification a non-viscous food (that is, a soup-like food product) will be defined as a food with at least 30% of its volume comprising free-flowing liquid with a room temperature viscosity of less than 2,000 centipoise (approximate viscosity of corn syrup). The viscosity of this liquid will be measured after filtering the food product to remove 90% of solid particles greater than 100 microns and 99% of solid particles greater than 300 microns.

The container with the non-viscous food can be placed with its flange resting on a circular hoop located at the top of a wire rack. The rack can have a single rod with two leg sections descending from a handle section. Two points on the rack's hoop will be attached to the junction between the handle section and the two leg sections. Also, an identical rod with a handle and two leg sections is attached to the opposite side of the hoop, thereby providing a second handle and another pair of legs.

In this embodiment the handles project outwardly and have a depressed, concave section providing clearance for portions of the containers flange that overhang the upper hoop.

A larger reinforcing hoop is attached at 90° intervals at a point near the bottom of each of the four legs. Because these legs flare outwardly, wire racks can be compactly nested by inserting the upper hoop of one rack through the larger lower hoop of another rack. Also, this outward flaring provides a stable base that is wider than the container and the upper hoop.

In this disclosed embodiment the lower tail of the leg extending below the lower hoop is bent upwardly to attach again to the lower hoop and form a V-shaped or U-shaped foot.

In one embodiment a cradling rod is formed with a horizontal section and two struts that project upwardly and attach near a junction of the upper hoop and handle. In this embodiment a second cradling rod is also attached in a similar manner but at different locations along the upper hoop. The horizontal sections of the two cradling rods can be either parallel or may cross. In either event, a container inserted through the upper hoop can be supported underneath by the horizontal sections of the cradling rods.

The struts of these cradling rods converge inwardly toward the bottom sections to provide clearance for the stacking of racks. Specifically, the upper hoop of one rack can be slid up between the inwardly converging struts and the outwardly diverging legs so that the racks can nest compactly.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a perspective view showing a container about to be placed on a rack over a combustion heater to form a warmer for soup or other non-viscous food products;

FIG. 2 is a top plan view of the rack of FIG. 1;

FIG. 3 is a perspective view of a rack that is an alternate to that of FIG. 1;

FIG. 4 is a perspective view of a rack that is an alternate to that of FIGS. 1 and 3; and

FIG. 5 is a detailed, fragmentary, cross-sectional view taken along line 5-5 of FIG. 4 and showing some features applicable to any of a the foregoing racks.

### DETAILED DESCRIPTION OF THE PREFERRED EMBODIMENTS

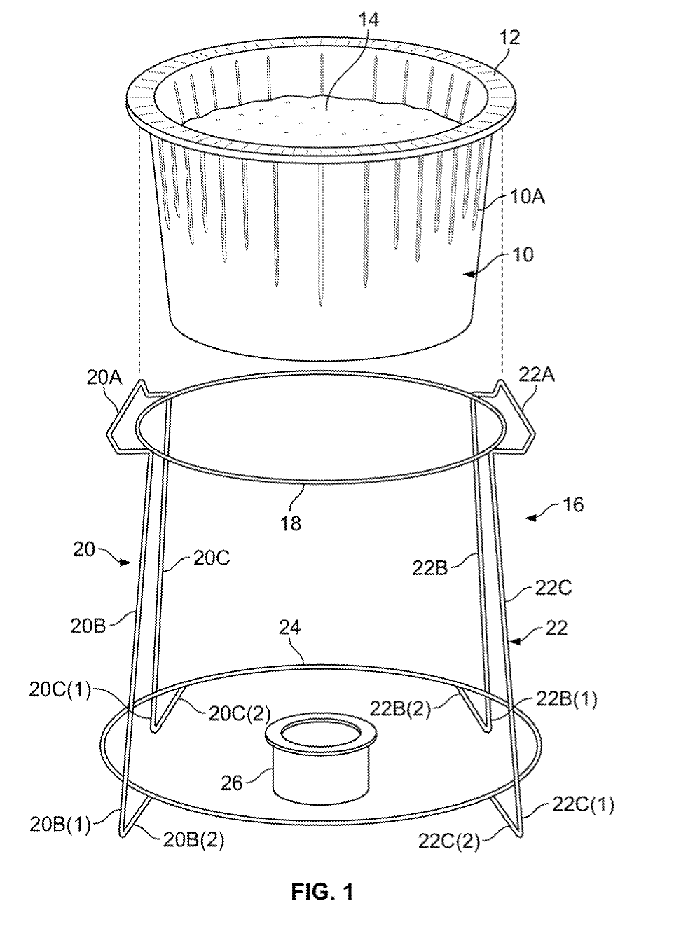

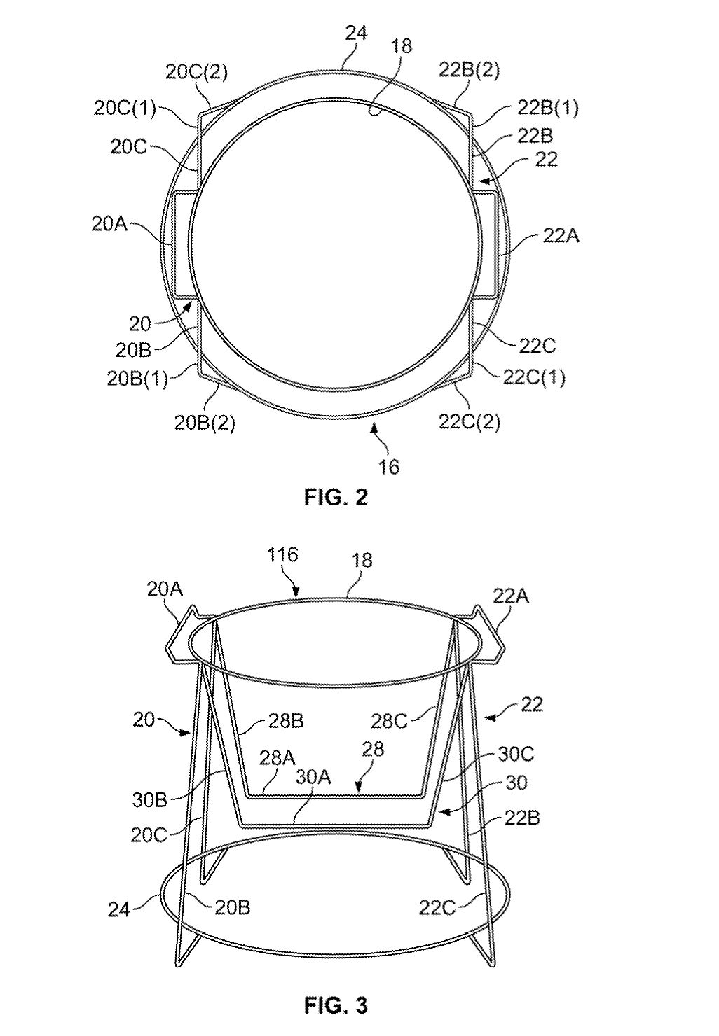

Referring to FIGS. 1 and 2, the illustrated warmer employs a round container 10 formed from sheet metal, specifically sheet aluminum of a relatively thin gauge to make the container relatively inexpensive and therefore disposable. For example, the container can be stamped from 45 gauge aluminum foil, although a different metal and gauge can be used depending upon the desired strength, size, durability, weight, etc. Sidewall 10A is wrinkled for added strength and rigidity and is made with a small draft (i.e., sidewall is frustroconical).

Container 10 is also formed with a flat, radially extending flange 12, which is made by starting with a larger flange that is then folded under two times (although other flanges may be folded differently or not folded at all). Flange 12 may also be wrinkled, which again increases strength and rigidity.

Container 10 is shown filled with a soup 14 although other types of foods may be placed therein. A container for non-viscous food such as soup should not be too shallow. Carrying a relatively shallow tray filled with liquid would frequently lead to spillage, due to the unavoidable disturbances such as a slight tipping of the tray or the inevitable wave motion occurring when moving the tray. For this reason container 10 has a relatively high ratio of height to width (the width being defined as the overall width, which here will be the outside diameter for circular flange 12). In particular, the inventor has determined that the container height ought to be at least three quarters of the overall width. A closely related criteria would be to require that the depth of the food 14 be at least three quarters of the overall width (using only 90% of the possible depth to avoid filling the container up to the very brim). Even better immunity from spillage can be achieved if the container height is at least equal to the overall width.

Rack 16 is shown made from rods of metal such as steel, stainless steel, aluminum, etc. These rods may be round metal stock, ⅛ inch (3 mm) in diameter, although other shapes and dimensions can be used in other embodiments. Rack 16 has a circular hoop with a diameter sized to fit into the inside corner between flange 12 and sidewall 10A of container 10.

A single bent metal rod 20 with a uniform circular cross-section has a handle section 20A and an integral pair of legs 20B and 20C. Handle 20A has a horizontal midsection supported on two L-shaped side arms. Legs 20B and 20C extend downwardly and flare outwardly. The two sharp bends marking the junction between handle 20A and legs 20B and 20C are welded to hoop 18, typically on its underside. Welded in the same way on the opposite side of hoop 18 is another identical, unitary metal rod 22 having handle 22A and legs 22B and 22C. Structures 20 and 22 are so attached to hoop 18 that they are mirror images of each other.

Ring 24 is a circular hoop made of the typical round metal rod used throughout the rack 16. Ring 24 is welded to the inside of legs 20B, 20C, 22B and 22C, near the bottom of the legs. Ring 24 has a greater diameter than hoop 18 and is sized to accommodate the outward flare legs of 20B, 20C, 22B and 22C at an angle of about 2-10° from vertical. It will be appreciated that the legs 20B, 20C, 22B and 22C may be flared at different angles and in some embodiments the legs may be curved to create additional clearance or to increase the effective size of the support base.

Foot segment 20B(1) of leg 20B extends collinearly below ring 24 and integrally connects to foot segment 20B(2) through a sharp 600 bend (bending away from leg 20C), although bends of other angles are contemplated. Foot segment 20B(2) reaches upwardly and terminates on ring 24, being attached thereto by welding. Segments 20B(1) and 20B(2) form a hooked portion that is attached twice to ring 24 and is referred to as a foot. As shown in FIG. 2, foot 20B(1)-20B(2) and ring 24 are outside the compass of hoop 18. In this description being outside the compass of hoop 18 means that a component appears to be to the outside of the hoop 18 when viewed in an overhead plan view.

Leg 20C also extends downwardly and outwardly and is welded to the outside of ring 24. Collinear foot segment 20C(1) extends downwardly to a bend from where foot segment 20C(2) ascends upwardly to terminate on ring 24, being attached thereto by welding. As shown in FIG. 2 foot segment 20C(2) extends clockwise from segment 20C(1), while foot segment 20B(2) extends counterclockwise from its foot segment 20B(1).

Foot 22B(1)-22B(2) and foot 22C(1)-22C(2) of rod 22 are attached to ring 24 in a similar manner and will be mirror images of the feet 20B(1)-20B(2) and 20C(1)-20C(2) of rod 20. All of these feet will be spaced to provide support distributed equidistantly around rack 16.

Combustion heater 26 is shown as a can filled with a combustible gel. Such a product is currently sold under the trademark Sterno™. Combustion heater 26 is shown simply placed concentrically within the compass of ring 24, although some embodiments will have structure to hold or more heaters in a predetermined position. It will be appreciated that the warmer will be sized so that when container 10 is placed in hoop 18 of rack 16, there will be adequate clearance under the container 10 for combustion heater 26 and its flame. As an example, some embodiments will have at least 5 inches (12.7 cm) of clearance under container 10 to accommodate a heater 26 that is 2½ inches (6.3 cm) tall, although this clearance will vary depending upon the type of heater and the amount of room deemed appropriate to support proper flame production.

Referring to FIG. 3, the previously described rack (rack 16 of FIG. 1) is supplemented with two subjacent supports 28 and 30 and is now identified as rack 116. Rack 116 has as before hoops 18 and 24 interconnected by rod structures 20 and 22. Components in this Figure that are identical to those previously illustrated in FIG. 1 bear the same reference numerals.

Support 28 is a metal rod bent into a U-shape and made of the same stock as the other rods of rack 116. Support 28 has two struts 28B and 28C that inwardly converge to horizontal support section 28A. Support 30 has an identical form composed of horizontal section 30A and struts 30B and 30C. The top of strut 28B is welded at the top of leg 20C near handle 20A. The top of strut 28C is welded at the top of leg 22B near handle 22A. The top of strut 30B is welded at the top of leg 20B near handle 20A. The top of strut 30C is welded at the top of leg 22C near handle 22A. Supports 28 and 30 are attached so that horizontal sections 28A and 30A are parallel and lie in the same horizontal plane.

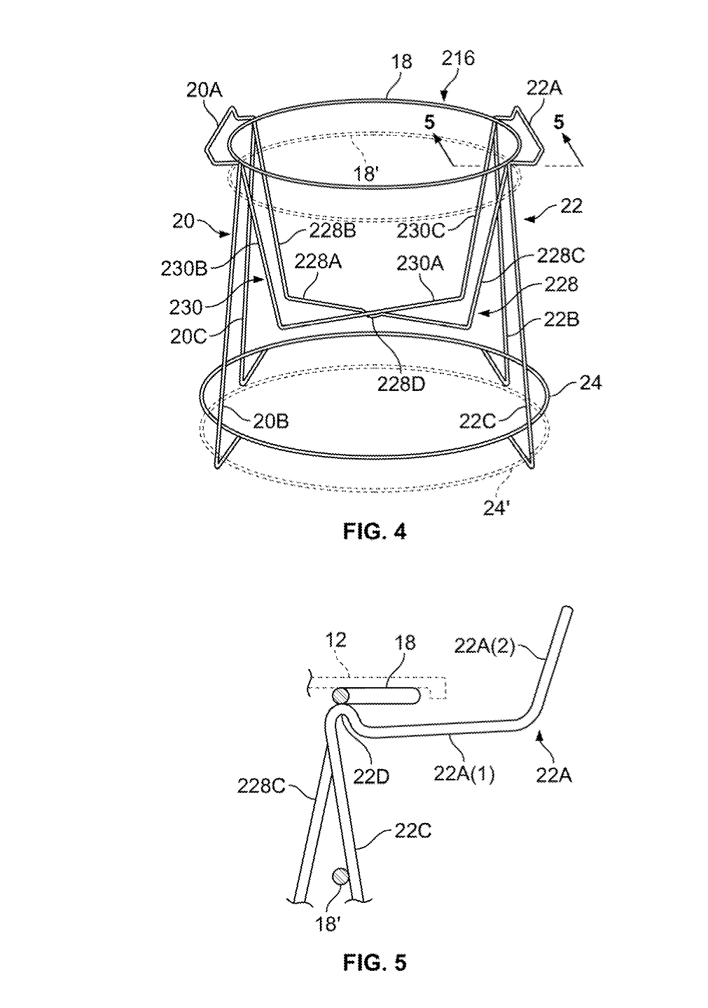

Referring to FIG. 4, the previously described rack (rack 16 of FIG. 1) has been supplemented with two subjacent supports 228 and 230 and is now identified as rack 216. Rack 216 again has hoops 18 and 24 interconnected by rod structures 20 and 22. Components in this Figure that are identical to those previously illustrated in FIG. 1 bear the same reference numerals.

Previously mentioned support 228 is a metal rod bent into a U-shape and made of the same stock as the other rods of rack 216. Support 228 has two struts 228B and 228C that inwardly converge to horizontal support section 228A. Support 230 has an identical form composed of horizontal section 230A and struts 230B and 230C. The top of strut 228B is welded at the top of leg 20C near handle 20A. The top of strut 228C is welded at the top of leg 22C near handle 22A. The top of strut 230B is welded at the top of leg 20B near handle 20A. The top of strut 230C is welded at the top of leg 22B near handle 22A.

Supports 228 and 230 are attached so that horizontal sections 228A and 230A cross. Horizontal sections 228A and 230A lie in the same horizontal plane for the most part. Section 228A has a shallow bight 228D to accommodate the crossing over by section 230A.

Referring now to FIGS. 4 and 5, it will be apparent how racks such as rack 216 can nest together to form a relatively compact stack. In FIG. 4 another rack is suggested by the illustration in phantom of hoops 18′ and 24′, which will be understood to correspond to hoops 18 and 24 of a rack like rack 216. Hoop 18′ may be inserted upwardly through hoop 24 to the inside of rods 20 and 22 and to the outside of supports 228 and 230. In FIG. 5 hoop 18′ is shown to have risen until it bears against the inside of leg 22C. It will be understood that ring 18′ likewise bears against the inside of legs 22B, 20B and 20C. Hoop 24′ will rise just slightly within the ambit of legs 22B, 22C, 20B and 20C but will remain spaced from hoop 24.

In this embodiment the hoop to hoop spacing between hoops 18 and 18′ is about one quarter of the overall height of rack 216, although in other embodiments a different hoop to hoop spacing may be employed. For example, the hoop to hoop spacing may be greater; for example, it may be half of the overall height of rack 216 (or even greater). The degree of nesting will be affected by how rapidly the legs 20B, 20C, 22B and 22C converge onto hoop 18.

In FIG. 5 the junction between leg 22C and handle 22A takes the form of a small bight 22D that is welded to the underside of 18. The proximal handle portion 22A(1) is depressed and thereby provides clearance for any portions of the previously mentioned flange (flange 12 of FIG. 1) that may overhang hoop 18. Consequently, this depressed portion 22A(1) may be considered a concave portion. It will be understood that in some embodiments the handle need not have a concave portion. Concave portion 22A(1) projects outwardly and supports the balance 22A(2) of handle 22A. Only one side of handle 22A is illustrated, but it will be understood that both the right and left sides are symmetrical. Also, opposite handle 20A will have the same configuration.

It will be appreciated that these features of FIG. 5 may be incorporated in the embodiments of FIGS. 1 and 3, to the extent applicable.

To facilitate an understanding of the principles associated with the foregoing apparatus, its operation will be briefly described in connection with the embodiment of FIGS. 1 and 2. It will be appreciated that the operation of the embodiments of FIGS. 3-5 will be essentially the same except that those embodiments have the added subjacent support for the food container.

Soup or other non-viscous food may be prepared in a home kitchen or the kitchen of a commercial caterer. This food may be prepared using ordinary kitchenware such as pots and pans before being poured into container 10. Some dishes may be prepared and cooked directly in container 10. Because container 10 is relatively deep, food product 14 will not tend to slosh back and forth and spill.

For a commercial caterer container 10 may be covered with a thin aluminum lid that is crimped onto the container before being placed in a delivery vehicle. More than one such container can be prepared and loaded in the delivery vehicle.

Rack 16 may also be placed in a delivery vehicle. Rack 16 may have been stored as part of a nested stack and when more than one rack is required, racks can be placed in the vehicle as a nested stack. Complementary racks 16 are nested by inserting hoop 18 of one rack through ring 24 of another rack. Since legs 20B, 20C, 22B and 22C flare outwardly the inserted ring can rise close to the corresponding ring 18 to produce a compact stack.

Of course the delivery vehicle may be loaded with various other types of food products in different size containers. In some cases these containers may be simple boxes or wrappers.

After arriving at the serving site, rack 16 and racks like it can be separated and placed on a serving table (not shown). Container 10 can then be inserted through ring 18 so flange 12 will rest on ring 18. For embodiments having handles 20A and 22A with a depressed section 22A(1) as shown FIG. 5, portions of the flange 12 can overhang ring 18 without touching the handles.

There is clearance under container 10 for combustion heater 26, a metal container filled with a combustible gel and placed on the serving table. This gel can be ignited to heat the food 14 or at least keep it warm. Any aluminum foil covering container 10 can be removed now or later just before service of the food.

Being relatively deep, container 10 will tend to be relatively heavy so that rack 16 will have a tendency to be top-heavy. However, the feet at the bottom of legs 20B, 20C, 22B and 22C are equidistantly spaced and provide a wide base reaching beyond the compass of hoop 18. Therefore, the rack 16 and container 10 will be stable and will be unlikely to tip. Stability can be important when consumers may be dipping a ladle into container 10 and possibly stirring the food 14.

When service is done combustion heater 26 can be extinguished and food container 10 discarded. Alternatively, if some of the food 14 is left over, container 10 can be covered with aluminum foil, plastic sheet, or the like and stored in a refrigerator or freezer. Eventually, when the contents of container 10 are later consumed the container can be discarded at that time.

The homeowner or caterer can stack racks 16 as before for easy storage and easy transportation.

The racks of FIGS. 3 and 4 will be used in a similar fashion. However, containers inserted through ring 18 will be supported on the supports 28 and 30 of FIG. 3 or supports 228 and 230 of FIG. 4. This subjacent support will supplement the support provided by ring 18 to flange 12 of container 10 (FIG. 1). This double support can be important since container 10 can be relatively deep and the weight ordinarily supported through flange 24 can be exceptionally high. Moreover, at times container 10 or the rack with container can be jarred or dropped from a small height. Under those circumstances high stresses may be applied to flange 12, in which case the additional subjacent support can be very important.

It is appreciated that various modifications may be implemented with respect to the above described embodiments. While racks for holding round containers are disclosed, other embodiments may be adapted to hold containers whose mouths are oval, polygonal, etc. Also, the number of rack legs can be different from that disclosed herein. These legs are shown reinforced by a circular ring but in other embodiments reinforcement may be performed with a number of struts that are straight, bent, or curved in various ways. Also, while the illustrated feet are legs that are bent back and attached to the ring, in some embodiments the leg may terminate in a simple loop or be fitted with a rubber cap. In addition, instead of round stock, rods having a different cross-section can be used. In some cases the structural elements may have cross-sections shaped like an I, a C; or the elements may be tubular. Moreover, the type of structural elements used in one portion of the rack may differ from those in other portions. Also, in some embodiments the handles may have different shapes, may be different in number, or may be eliminated. Additionally, while the description often mentions containers holding soup, a variety of other food products can be held in the container. Additionally, the containers can be formed from plastics or other materials, using a thin gauge if the container is to be disposable.

Obviously, many modifications and variations of the present invention are possible in light of the above teachings. It is therefore to be understood that within the scope of the appended claims, the invention may be practiced otherwise than as specifically described.

1. A container rack adapted to hold a flanged, sheet metal container whose height is at least three quarters of its overall width, said rack comprising:
a hoop dimensioned to receive said container and support it at least partially on its flange;
at least four legs supporting said hoop and extending downwardly and outwardly, said legs terminating in feet spaced equidistantly in a pattern exceeding the compass of said hoop.

2. A container rack according to claim 1 comprising:
a ring mounted below said hoop and attached to each of said at least four legs.

3. A container rack according to claim 2 wherein each of said at least four legs has a hooked portion that extends below said ring, said hooked portion attaching twice to said ring at different points thereon.

4. A container rack according to claim 3 comprising:
a pair of handles attached to and extending outwardly from said hoop.

5. A container rack according to claim 1 comprising:
a handle attached to and extending outwardly from said hoop, a concave portion of said handle adjacent to said hoop being depressed to provide clearance for the containers flange.

6. A container rack according to claim 1 wherein said hoop is circular.

7. A container rack according to claim 6 wherein said hoop is sized and positioned to support the container should its height exceed its diameter.

8. A container rack according to claim 7 wherein said hoop and said legs each have a uniform circular cross-section.

9. A container rack according to claim 1 wherein said rack is nestable in that said at least four legs flare outwardly to provide clearance for the hoop of another rack to be inserted between said legs and provide nesting with a hoop to hoop spacing that is no more than one quarter of the overall height of said rack.

10. A container rack according to claim 1 comprising:
a subjacent support for the container, the support having a plurality of inwardly converging struts.

11. A container rack according to claim 10 wherein said plurality of struts comprise at least one U-shaped rod having a pair of upper ends attached to said rack near said hoop.

12. A container rack according to claim 10 wherein said plurality of struts comprise at least two U-shaped rods having a pair of upper ends attached to said rack near said hoop.

13. A container rack according to claim 12 wherein said at least two U-shaped rods cross.

14. A warmer for a food comprising:
a sheet metal container having a flange;
a rack adapted to hold said container, said rack including (a) a hoop dimensioned to receive said container and support it on its flange, and (b) a plurality of legs attached to the rack near said hoop, said legs extending downwardly and outwardly and terminating in feet spaced equidistantly in a pattern exceeding the compass of said hoop, said rack providing clearance under said container for combustion heating.

15. A warmer according to claim 14 comprising:
a ring mounted below said hoop and attached to each of said plurality of legs.

16. A warmer according to claim 15 wherein each of said legs has a hooked portion that extends below said ring, said hooked portion attaching twice to said ring at different points thereon.

17. A warmer according to claim 16 comprising:
a pair of handles attached to and extending outwardly from said hoop, each of said handles being attached to and extending outwardly from said hoop, a concave portion of said handle adjacent to said hoop being depressed to provide clearance for the container's flange.

18. A warmer according to claim 14 wherein said hoop is circular and is sized and positioned to support the container should its height exceed its width, said container having a wrinkled sidewall, said warmer having a combustion heater sized to fit under said container when mounted in said rack.

19. A warmer according to claim 14 wherein said rack is nestable in that said at least four legs flare outwardly to provide clearance for the hoop of another rack to be inserted between said legs and provide nesting with a hoop to hoop spacing that is no more than one quarter of the overall height of said rack.

20. A warmer according to claim 14 comprising:
a subjacent support for the bottom of the container, the support having a plurality of inwardly converging struts.

21. A warmer according to claim 20 wherein said plurality of struts comprise at least one U-shaped rod having a pair of upper ends attached to said rack near said hoop.

22. A warmer according to claim 20 wherein said plurality of struts comprise at least two U-shaped rods having a pair of upper ends attached to said rack near said hoop.

23. A warmer according to claim 22 wherein said at least two U-shaped rods cross.

24. A method for warming a non-viscous food employing a flanged, sheet metal container, comprising the steps of:
filling the container with the food;
supporting the container at least partially on its flange with clearance below the container;
applying combustion heat under and directly to said container; and
discarding said container after one use.

25. A method according to claim 24 wherein the step of filling the container with the food is performed in a first building before being transported by motor vehicle to a second building where the steps of supporting and applying combustion heat to the container are performed.

26. A method according to claim 25 employing a plurality of racks having a hoop for holding the container on its flange, the method comprising the step of:
nesting said plurality of racks at said first building with a hoop to hoop spacing less than half the overall height of each one of the racks.

27. A method according to claim 24 employing a plurality of racks and wherein the step of supporting the container is performed by providing support to the container's flange and to the bottom of said container, the method including the step of:
nesting said plurality of racks with a hoop to hoop spacing less than half the overall height of each one of the racks.

28. A method according to claim 24 wherein the step of filling the container is performed in order to fill the container to a depth that is at least three quarters of the width of the container.
